(19) United States
(12) Patent Application Publication
(10) Pub. No.: US 2026/0202698 A1
(43) Pub. Date: Jul. 16, 2026

(54) ELECTRICALLY CONTROLLED VIEWING ANGLE SWITCHING DEVICE AND DISPLAY APPARATUS

(71) Applicant: Coretronic Corporation, Hsin-Chu (TW)

(72) Inventors: Yang-Ching Lin, Hsin-Chu (TW); Ping-Yen Chen, Hsin-Chu (TW); Chung-Yang Fang, Hsin-Chu (TW)

(73) Assignee: Coretronic Corporation, Hsin-Chu (TW)

(21) Appl. No.: 19/438,648

(22) Filed: Jan. 1, 2026

(30) Foreign Application Priority Data
Jan. 14, 2025 (CN) 202520079234.3

(51) Int. Cl. G02F 1/13; G02F 1/13357; G02F 1/13363; G02F 1/1337

(52) U.S. Cl. CPC G02F 1/1323; G02F 1/133603; G02F 1/133638; G02F 1/1337

(57) ABSTRACT

An electrically controlled viewing angle switching device includes a first substrate, a second substrate, a first liquid crystal layer, a first alignment layer, a second alignment layer, a plurality of spacers, a first polarizer and a second polarizer. An included angle between a first alignment direction of the first alignment layer and a second alignment direction of the second alignment layer is between 165 degrees and 195 degrees. Each of the plurality of spacers has a height greater than 5 μm. An included angle between a first absorption axis of the first polarizer and the first alignment direction is between 0 degrees and 15 degrees or between 75 degrees and 105 degrees. An included angle between a second absorption axis of the second polarizer and the second alignment direction is between 0 degrees and 15 degrees or between 75 degrees and 105 degrees.

### CROSS-REFERENCE TO RELATED APPLICATION

This application claims the priority benefit of China application serial no. 202520079234.3, filed on January 14, 2025. The entirety of the above-mentioned patent application is hereby incorporated by reference herein and made a part of this specification.

### BACKGROUND

### Technical Field

The disclosure relates to a display apparatus provided with an electrically controlled switching device, and particularly relates to a display apparatus provided with an electrically controlled viewing angle switching device.

### Description of Related Art

To provide a display apparatus with an anti-peeping function, a technical solution has been proposed in which an electrically controllable viewing angle control device is placed above a display panel. Generally, such a viewing angle control device is, for example, a liquid crystal device with an electrically controllable phase retardation. During the manufacturing process of the liquid crystal device, a cavity between two transparent substrates is injected with liquid crystal material to form a liquid crystal layer for modulating light. With the increasing market demand for lightweight and flexible display apparatus, not only the display panel but also the substrates used in the viewing angle control device has gradually adopted flexible substrates. However, the flexibility of the flexible substrates affects the thickness uniformity of the liquid crystal layer during the manufacturing process, leading to degradation in both display brightness and viewing angle uniformity of the display apparatus.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a display apparatus equipped with an electrically controlled viewing angle switching device, featuring excellent brightness uniformity of the display image and process stability.

The other objectives and advantages of the disclosure may be further understood from the descriptive features disclosed in the disclosure.

In order to achieve one or a part or all of the above purposes or other purposes, an embodiment of the disclosure provides an electrically controlled viewing angle switching device. The electrically controlled viewing angle switching device includes a first substrate, a second substrate, a first liquid crystal layer, a first alignment layer, a second alignment layer, a plurality of spacers, a first polarizer and a second polarizer. The first substrate and the second substrate are overlapped with each other along a stacking direction. The first liquid crystal layer is disposed between the first substrate and the second substrate. The first alignment layer is disposed between the first substrate and the first liquid crystal layer and has a first alignment direction. The second alignment layer is disposed between the second substrate and the first liquid crystal layer and has a second alignment direction. An included angle between the first alignment direction and the second alignment direction is in a range of 165 degrees to 195 degrees. The plurality of spacers are disposed between the first substrate and the second substrate. Each of the plurality of spacers has a height greater than 5 μm along the stacking direction. The first polarizer is disposed on one side of the first alignment layer facing away from the first liquid crystal layer and has a first absorption axis. An included angle between an axial direction of the first absorption axis and the first alignment direction is in a range of 0 degrees to 15 degrees or in a range of 75 degrees to 105 degrees. The second polarizer is disposed on one side of the second alignment layer facing away from the first liquid crystal layer and has a second absorption axis. An included angle between an axial direction of the second absorption axis and the second alignment direction is in a range of 0 degrees to 15 degrees or in a range of 75 degrees to 105 degrees.

In order to achieve one or a part or all of the above purposes or other purposes, an embodiment of the disclosure provides a display apparatus. The display apparatus includes a display panel and a first electrically controlled viewing angle switching device. The first electrically controlled viewing angle switching device is disposed overlapping the display panel and includes a first substrate, a second substrate, a first liquid crystal layer, a first alignment layer, a second alignment layer, a plurality of first spacers, a first polarizer and a second polarizer. The first substrate and the second substrate are overlapped with each other along a stacking direction. The first liquid crystal layer is disposed between the first substrate and the second substrate. The first alignment layer is disposed between the first substrate and the first liquid crystal layer and has a first alignment direction. The second alignment layer is disposed between the second substrate and the first liquid crystal layer and has a second alignment direction. An included angle between the first alignment direction and the second alignment direction is in a range of 165 degrees to 195 degrees. The plurality of first spacers are disposed between the first substrate and the second substrate. Each of the plurality of first spacers has a first height along the stacking direction. The first height is greater than 5 μm. The first polarizer is disposed on one side of the first alignment layer facing away from the first liquid crystal layer and has a first absorption axis. An included angle between an axial direction of the first absorption axis and the first alignment direction is in a range of 0 degrees to 15 degrees or in a range of 75 degrees to 105 degrees. The second polarizer is disposed on one side of the second alignment layer facing away from the first liquid crystal layer and has a second absorption axis. An included angle between an axial direction of the second absorption axis and the second alignment direction is in a range of 0 degrees to 15 degrees or in a range of 75 degrees to 105 degrees.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display apparatus according to a first embodiment of the disclosure.

FIG. 2 is a schematic diagram illustrating the configuration relationship between the alignment direction of the alignment layer, the axial direction of the absorption axis of the polarizer and the dual-sided anti-peeping axial direction in FIG. 1.

FIG. 3A is a schematic front view of the plurality of first spacers of FIG. 1 distributed on the first substrate.

FIG. 3B is a schematic front view of the plurality of first spacers distributed on the first substrate according to another variant embodiment of FIG. 3A.

FIG. 4 is a schematic cross-sectional view of a display apparatus according to a second embodiment of the disclosure.

FIG. 5 is a schematic diagram illustrating the configuration relationship between the alignment direction of the alignment layer, the axial direction of the absorption axis of the polarizer and the dual-sided anti-peeping axial direction in FIG. 4.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

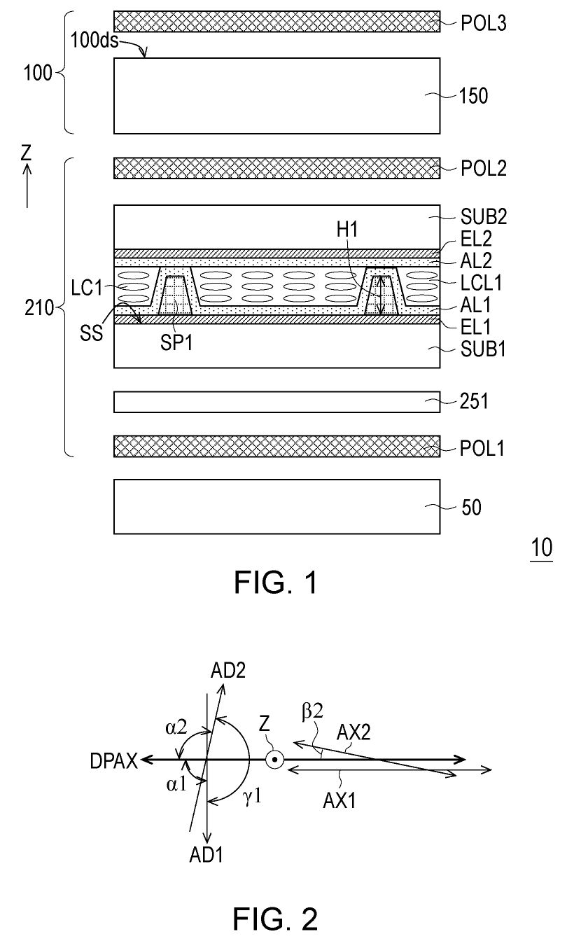

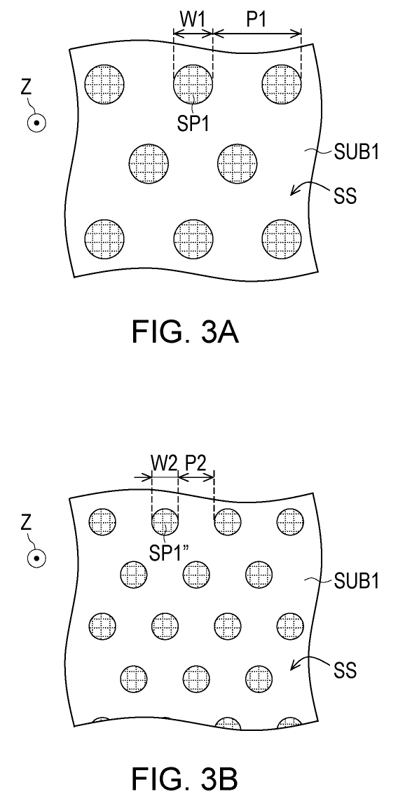

FIG. 1 is a schematic cross-sectional view of a display apparatus according to a first embodiment of the disclosure. FIG. 2 is a schematic diagram illustrating the configuration relationship between the alignment direction of the alignment layer, the axial direction of the absorption axis of the polarizer and the dual-sided anti-peeping axial direction in FIG. 1. FIG. 3A is a schematic front view of the plurality of first spacers of FIG. 1 distributed on the first substrate. FIG. 3B is a schematic front view of the plurality of first spacers distributed on the first substrate according to another variant embodiment of FIG. 3A. It is particularly noted that the angular configuration relationship shown in FIG. 2 is, for example, the angular configuration relationship of the display apparatus 10 in FIG. 1 in a top-view direction (e.g., direction Z).

Referring to FIG. 1, a display apparatus 10 includes a backlight module 50, a display panel 100 and a first electrically controlled viewing angle switching device 210 which are overlapped with each other. The first electrically controlled viewing angle switching device 210 is disposed between the display panel 100 and the backlight module 50, that is, the backlight module 50 is disposed on one side of the first electrically controlled viewing angle switching device 210 facing away from the display panel 100, but the disclosure is not limited thereto. In other embodiments, the first electrically controlled viewing angle switching device 210 may be disposed on one side of a display surface 100ds (e.g., the surface where the display light beam leaves the display panel 100) of the display panel 100. In the embodiment, the display panel 100 is a non-self-emissive display panel, and the backlight module 50 may serve as an illumination light source required for the display of the display panel 100.

In the embodiment, the first electrically controlled viewing angle switching device 210 includes a first substrate SUB1, a second substrate SUB2, a first liquid crystal layer LCL1, a first alignment layer AL1 and a second alignment layer AL2, and the first substrate SUB1, the second substrate SUB2, the first liquid crystal layer LCL1, the first alignment layer AL1 and the second alignment layer AL2 are overlapped with each other along a stacking direction (e.g., direction Z). The first alignment layer AL1 is disposed on the first substrate SUB1 and is located between the first liquid crystal layer LCL1 and the first substrate SUB1. The second alignment layer AL2 is disposed on the second substrate SUB2 and is located between the first liquid crystal layer LCL1 and the second substrate SUB2. The first liquid crystal layer LCL1 is disposed between the first alignment layer AL1 and the second alignment layer AL2 (or between the first substrate SUB1 and the second substrate SUB2).

The first substrate SUB1 and the second substrate SUB2 may be flexible substrates, and their materials include, for example, triacetate (TAC), cyclo-olefin polymer (COP), polycarbonate (PC), polymethyl methacrylate (PMMA), polyimide (PI), polyethylene naphthalate (PEN) and other suitable polymers or sheets with phase retardation (such as stretched compensation films).

It is particularly noted that the first alignment layer AL1 and the second alignment layer AL2 of the first electrically controlled viewing angle switching device 210 are configured to determine the alignment state of the first liquid crystal layer LCL1 in a natural state (e.g., when not subjected to an electric field). In order to drive the first liquid crystal layer LCL1, the first electrically controlled viewing angle switching device 210 may further include a first electrode layer EL1 and a second electrode layer EL2. In the embodiment, the first electrode layer EL1 is disposed between the first substrate SUB1 and the first alignment layer AL1, and the second electrode layer EL2 is disposed between the second substrate SUB2 and the second alignment layer AL2. When the two electrode layers are enabled to have a potential difference, a plurality of first liquid crystal molecules LC1 of the first liquid crystal layer LCL1 are deflected by the electric field formed between the two electrode layers. The first electrode layer EL1 and the second electrode layer EL2 are, for example, light-transmissive electrodes, and the material of the light-transmissive electrodes may include metal oxides, such as indium tin oxide, indium zinc oxide, aluminum tin oxide, aluminum zinc oxide, or other suitable oxides, or a stacked layer of at least two of the above, but the disclosure is not limited thereto.

First, it should be noted that by adjusting the applied voltage between the first electrode layer EL1 and the second electrode layer EL2 of the first electrically controlled viewing angle switching device 210, the display apparatus 10 can switch between a sharing mode and an anti-peeping mode. For example, when a first voltage is applied between the first electrode layer EL1 and the second electrode layer EL2, the display apparatus 10 operates in the anti-peeping mode. When a second voltage is applied between the first electrode layer EL1 and the second electrode layer EL2, the display apparatus 10 operates in the sharing mode, but the disclosure is not limited thereto.

The liquid crystal layer of the first electrically controlled viewing angle switching device 210 may be driven in a twisted-nematic (TN) mode or an electrically controlled birefringence (ECB) mode. For example, in the embodiment, the first electrically controlled viewing angle switching device 210 is driven in the ECB mode, and the first liquid crystal layer LCL1 is, for example, a positive liquid crystal, but the disclosure is not limited thereto.

Furthermore, the first electrically controlled viewing angle switching device 210 further includes a first polarizer POL1 and a second polarizer POL2. The first polarizer POL1 is disposed on one side of the first alignment layer AL1 facing away from the first liquid crystal layer LCL1 and is located between the first alignment layer AL1 and the backlight module 50. The second polarizer POL2 is disposed on one side of the second alignment layer AL2 facing away from the first liquid crystal layer LCL1, and is located between the second alignment layer AL2 and the display panel 100. The first polarizer POL1 and the second polarizer POL2 have a first absorption axis AX1 and a second absorption axis AX2 respectively. In the embodiment, the display panel 100 may include an electrically controlled liquid crystal cell 150 and a third polarizer POL3, and the electrically controlled liquid crystal cell 150 is disposed between the second polarizer POL2 and the third polarizer POL3.

Referring to FIG. 1 and FIG. 2, in the embodiment, the first electrically controlled viewing angle switching device 210 has a dual-sided anti-peeping axial direction DPAX perpendicular to the direction Z. In detail, the dual-sided anti-peeping axial direction DPAX includes a 90-degree direction and a -90-degree direction that are opposite to each other in the same dimension (e.g., the horizontal dimension in FIG. 2, whose viewing angle is from 90 degrees to -90 degrees, where the viewing angle of 0 degrees is a normal viewing direction (e.g., direction Z)). The 90-degree direction is, for example, a direction toward the right side in FIG. 2, and the -90-degree direction is, for example, a direction toward the left side in FIG. 2.

In the embodiment, an included angle α1 between a first alignment direction AD1 of the first alignment layer AL1 and the -90-degree direction of the dual-sided anti-peeping axial direction DPAX may be 90 degrees, that is, the first alignment direction AD1 is perpendicular to the dual-sided anti-peeping axial direction DPAX. An included angle α2 between a second alignment direction AD2 of the second alignment layer AL2 and the -90-degree direction of the dual-sided anti-peeping axial direction DPAX may be 95 degrees. That is, an included angle γ1 between the first alignment direction AD1 and the second alignment direction AD2 is 175 degrees, but the disclosure is not limited thereto. In other embodiments, the included angle γ1 between the first alignment direction AD1 and the second alignment direction AD2 may be in a range of 165 degrees to 195 degrees.

In the embodiment, an axial direction of the first absorption axis AX1 of the first polarizer POL1 may be perpendicular to the first alignment direction AD1, and an axial direction of the second absorption axis AX2 of the second polarizer POL2 may be perpendicular to the second alignment direction AD2. An included angle β2 between the -90-degree direction of the dual-sided anti-peeping axial direction DPAX and the second absorption axis AX2 of the second polarizer POL2 is, for example, 5 degrees, but the disclosure is not limited thereto. In other embodiments, the axial direction of the first absorption axis AX1 may be parallel to the first alignment direction AD1, and the axial direction of the second absorption axis AX2 may be parallel to the second alignment direction AD2. Alternatively, the included angle between the axial direction of the first absorption axis AX1 and the first alignment direction AD1 and the included angle between the axial direction of the second absorption axis AX2 and the second alignment direction AD2 may each be in a range of 0 degrees to 15 degrees or in a range of 75 degrees to 105 degrees.

In order to control the thickness of the first liquid crystal layer LCL1, the first electrically controlled viewing angle switching device 210 further includes a plurality of first spacers SP1 between the first substrate SUB1 and the second substrate SUB2. It is particularly noted that a first height H1 of each of the first spacers SP1 along the stacking direction (e.g., direction Z) of the first substrate SUB1 and the second substrate SUB2 is greater than 5 μm. Preferably, the first height H1 may be less than or equal to 15 μm.

When the first substrate SUB1 and the second substrate SUB2 are flexible substrates, their flexibility may deteriorate the surface flatness of the substrates during the manufacturing process and affect the thickness uniformity of the first liquid crystal layer LCL1 between the two substrates. Therefore, the design of the first height H1 of the first spacer SP1 being greater than 5 μm can effectively reduce the influence of the thickness variation of the first liquid crystal layer LCL1 due to the surface flatness of the two substrates on the uniformity of the light output brightness of the first electrically controlled viewing angle switching device 210. In addition, the flexibility in controlling the amount of liquid crystal during filling may also be increased, thereby improving process stability and quality control.

On the other hand, in order to achieve optimal anti-peeping effect on the dual-sided anti-peeping axial direction DPAX of the display apparatus 10 at viewing angles of ±45 degrees, the maximum phase retardation of the first liquid crystal layer LCL1 may be in a range of 0.75 μm to 0.83 μm. Therefore, corresponding to the range design (i.e., greater than 5 μm and less than or equal to 15 μm) of the first height H1 of the first spacer SP1, the absolute difference between the refractive indices of the ordinary ray and the extraordinary ray of the first liquid crystal layer LCL1 may be in a range of 0.050 to 0.166. However, the disclosure is not limited thereto. In other embodiments, the maximum phase retardation of the first liquid crystal layer LCL1 may be adjusted according to the viewing angle design that provide the best anti-peeping effect for the display apparatus.

Furthermore, to enhance the supporting effect of the first spacers SP1 on the substrate, a percentage value of an orthographic projection area of the plurality of first spacers SP1 on a substrate surface SS of the first substrate SUB1 to an area of the substrate surface SS may be greater than 0.5% and less than 5%. Referring to FIG. 3A, for example, the first spacers SP1 may be arranged along at least one direction parallel to the substrate surface SS with a spacing P1, and each of the first spacers SP1 may have a maximum width W1 along any arrangement direction. Preferably, the maximum width W1 of the first spacer SP1 may be less than 20 μm, and the spacing P1 may be greater than 83.5 μm and less than 270 μm. It is particularly noted that if the maximum width W1 of the first spacer SP1 is less than 20 μm, the influence of the first spacers SP1 on the anti-peeping effect can be effectively reduced.

That is, in order to meet the support requirements for the substrate without affecting the anti-peeping effect, if the spacing between the first spacers SP1 is reduced, the maximum width of the first spacer SP1 must be reduced simultaneously. For example, as shown in FIG. 3B, in another variant embodiment, if the spacing P2 of the arrangement of the first spacers SP1” is smaller than the spacing P1 of the arrangement of the first spacers SP1 in FIG. 3A, the maximum width W2 of the first spacer SP1” must also be smaller than the maximum width W1 of the first spacer SP1 in FIG. 3A. If the first substrate SUB1 and the second substrate SUB2 in FIG. 1 are flexible substrates, the design ranges of the spacing and the maximum width of the first spacers SP1 allow the first electrically controlled viewing angle switching device 210 to maintain the uniformity of the thickness of its first liquid crystal layer LCL1 even when bent or subjected to pressure, helping to enhance its optical stability.

It should be noted that, in the embodiment, the orthographic projection profile of the first spacer SP1 on the substrate surface SS is illustrated by a circular shape as an exemplary demonstration, which does not mean that the disclosure is limited thereto. In other embodiments, the orthographic projection profile of the spacer on the substrate surface SS may be elliptical, square, rhomboid, polygonal, or any other suitable shape.

In the embodiment, the first electrically controlled viewing angle switching device 210 may further selectively include a compensation film 251. The compensation film 251 is disposed between the first polarizer POL1 and the first liquid crystal layer LCL1, that is, the compensation film 251 is disposed between the first polarizer POL1 and the second polarizer POL2. The out-of-plane phase retardation (Rth) of the compensation film 251 may be in a range of 100 nm to 500 nm. In the embodiment, the out-of-plane phase retardation of the compensation film 251 is, for example, 280 nm.

In the embodiment, the backlight module 50 is, for example, a light-concentrating backlight module, which at least includes a light guide plate and a low-scattering reflective sheet. In order to meet different light distribution requirements, the light-concentrating backlight module may be further provided with a reverse prism sheet, a light control film, at least one prism sheet, at least one diffusion sheet, or a combination thereof. It is particularly noted that the first polarizer POL1 may be a polarizer with low water absorption and low thermal expansion coefficient, such as a coated polarizer, to reduce the deformation effect of the polarizer caused by environmental humidity and temperature changes, thereby stabilizing the optical performance of the first electrically controlled viewing angle switching device 210.

Provided below are some other embodiments for illustrating the disclosure in detail, in which the same components will be denoted by the same reference numerals, and the description of the same technical content will be omitted. Please refer to the aforementioned embodiments for the omitted content, which will not be repeated below.

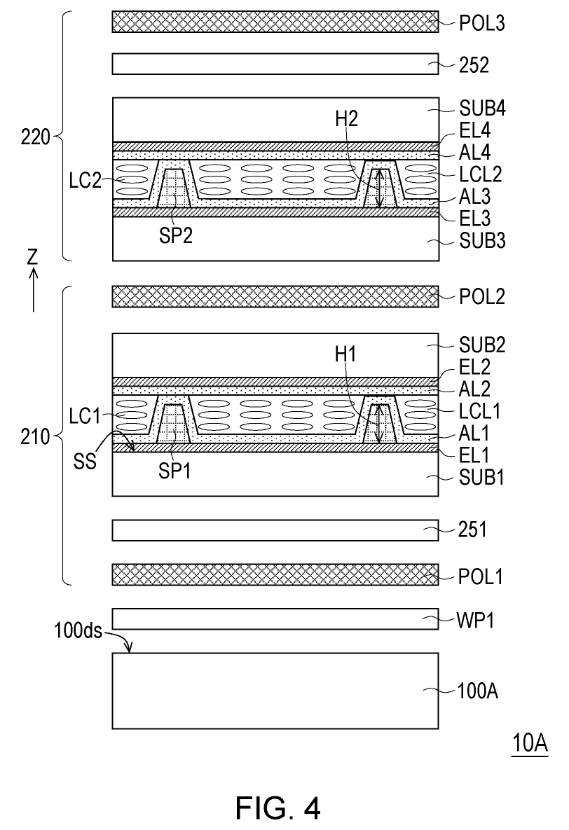

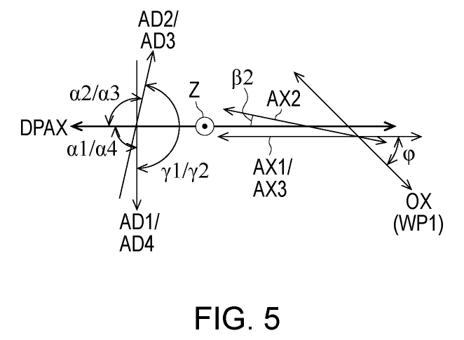

FIG. 4 is a schematic cross-sectional view of a display apparatus according to a second embodiment of the disclosure. FIG. 5 is a schematic diagram illustrating the configuration relationship between the alignment direction of the alignment layer, the axial direction of the absorption axis of the polarizer and the dual-sided anti-peeping axial direction in FIG. 4. It is particularly noted that the angular configuration relationship shown in FIG. 5 is, for example, the angular configuration relationship of the display apparatus 10A in FIG. 4 in a top-view direction (e.g., direction Z).

Referring to FIG. 4, the difference between a display apparatus 10A of the embodiment and the display apparatus 10 of FIG. 1 lies in that the type of display panel and the number of electrically controlled viewing angle switching device are different. Specifically, in the embodiment, the display panel 100A is, for example, a self-emissive display panel, and the first electrically controlled viewing angle switching device 210 is disposed on one side of the display surface 100ds of the display panel 100A. The first polarizer POL1 is located between the display panel 100A and the first liquid crystal layer LCL1. The second polarizer POL2 is located on one side of the first liquid crystal layer LCL1 facing away from the display panel 100A.

The display panel 100A is, for example, an organic light emitting diode (OLED) display panel, a micro light emitting diode (micro-LED) display panel, or a mini light emitting diode (mini-LED) display panel, but the disclosure is not limited thereto.

In the embodiment, the display apparatus 10A may further include a second electrically controlled viewing angle switching device 220 disposed on one side of the display surface 100ds of the display panel 100A and located on one side of the first electrically controlled viewing angle switching device 210 facing away from the display panel 100A. It is particularly noted that the display panel 100A and the first electrically controlled viewing angle switching device 210 are combined, for example, in an air bonding manner, and the first electrically controlled viewing angle switching device 210 and the second electrically controlled viewing angle switching device 220 are combined in a direct bonding manner, but the disclosure is not limited thereto.

Similar to the configuration of the first electrically controlled viewing angle switching device 210, the second electrically controlled viewing angle switching device 220 of the embodiment may include a third substrate SUB3, a fourth substrate SUB4, a second liquid crystal layer LCL2, a third alignment layer AL3 and a fourth alignment layer AL4, and the third substrate SUB3, the fourth substrate SUB4, the second liquid crystal layer LCL2, the third alignment layer AL3 and the fourth alignment layer AL4 are overlapped with each other in a stacking direction (e.g., direction Z). The third alignment layer AL3 is disposed on the third substrate SUB3 and is located between the second liquid crystal layer LCL2 and the third substrate SUB3. The fourth alignment layer AL4 is disposed on the fourth substrate SUB4 and is located between the second liquid crystal layer LCL2 and the fourth substrate SUB4. The second liquid crystal layer LCL2 is disposed between the third alignment layer AL3 and the fourth alignment layer AL4 (or between the third substrate SUB3 and the fourth substrate SUB4).

The third substrate SUB3 and the fourth substrate SUB4 may be flexible substrates, and their materials include, for example, triacetate (TAC), cyclo-olefin polymer (COP), polycarbonate (PC), polymethyl methacrylate (PMMA), polyimide (PI), polyethylene naphthalate (PEN) and other suitable polymers or sheets with phase retardation (such as stretched compensation films).

The third alignment layer AL3 and the fourth alignment layer AL4 of the second electrically controlled viewing angle switching device 220 are configured to determine the alignment state of the second liquid crystal layer LCL2 in a natural state (e.g., when not subjected to an electric field). In order to drive the second liquid crystal layer LCL2, the second electrically controlled viewing angle switching device 220 may further include a third electrode layer EL3 and a fourth electrode layer EL4. In the embodiment, the third electrode layer EL3 is disposed between the third substrate SUB3 and the third alignment layer AL3, and the fourth electrode layer EL4 is disposed between the fourth substrate SUB4 and the fourth alignment layer AL4. When the two electrode layers are enabled to have a potential difference, a plurality of second liquid crystal molecules LC2 of the second liquid crystal layer LCL2 are deflected by the electric field formed between the two electrode layers. The third electrode layer EL3 and the fourth electrode layer EL4 are, for example, light-transmissive electrodes, and the material of the light-transmissive electrodes may include metal oxides, such as indium tin oxide, indium zinc oxide, aluminum tin oxide, aluminum zinc oxide, or other suitable oxides, or a stacked layer of at least two of the above, but the disclosure is not limited thereto.

First, it should be noted that by adjusting the applied voltage between the first electrode layer EL1 and the second electrode layer EL2 of the first electrically controlled viewing angle switching device 210 and the applied voltage between the third electrode layer EL3 and the fourth electrode layer EL4 of the second electrically controlled viewing angle switching device 220, the display apparatus 10A can switch between a sharing mode and an anti-peeping mode. For example, when a first voltage is applied between the first electrode layer EL1 and the second electrode layer EL2 or/and a third voltage is applied between the third electrode layer EL3 and the fourth electrode layer EL4, the display apparatus 10A operates in the anti-peeping mode. When a second voltage is applied between the first electrode layer EL1 and the second electrode layer EL2, and a fourth voltage is applied between the third electrode layer EL3 and the fourth electrode layer EL4, the display apparatus 10A operates in the sharing mode.

The liquid crystal layer of the electrically controlled viewing angle switching device may be driven in a twisted-nematic (TN) mode or an electrically controlled birefringence (ECB) mode. For example, in the embodiment, the first electrically controlled viewing angle switching device 210 and the second electrically controlled viewing angle switching device 220 are both driven in the ECB mode, and the first liquid crystal layer LCL1 and the second liquid crystal layer LCL2 are both positive liquid crystals.

Furthermore, the second electrically controlled viewing angle switching device 220 further includes a third polarizer POL3. The third polarizer POL3 is disposed on one side of the second liquid crystal layer LCL2 facing away from the first electrically controlled viewing angle switching device 210 and has a third absorption axis AX3. The second polarizer POL2 is located between the first liquid crystal layer LCL1 and the second liquid crystal layer LCL2.

Referring to FIG. 4 and FIG. 5, in the embodiment, an included angle α3 between a third alignment direction AD3 of the third alignment layer AL3 and the -90-degree direction of the dual-sided anti-peeping axial direction DPAX may be 95 degrees. An included angle α4 between a fourth alignment direction AD4 of the fourth alignment layer AL4 and the -90-degree direction of the dual-sided anti-peeping axial direction DPAX may be 90 degrees. That is, an included angle γ2 between the third alignment direction AD3 and the fourth alignment direction AD4 is 175 degrees, but the disclosure is not limited thereto. In other embodiments, the included angle γ2 between the third alignment direction AD3 and the fourth alignment direction AD4 may be in a range of 165 degrees to 195 degrees.

More specifically, in the embodiment, the first alignment direction AD1 and the fourth alignment direction AD4 are parallel to each other and perpendicular to the dual-sided anti-peeping axial direction DPAX, and the second alignment direction AD2 is parallel to the third alignment direction AD3. In the embodiment, the axial direction of the first absorption axis AX1 of the first polarizer POL1 may be perpendicular to the first alignment direction AD1, and the axial direction of the third absorption axis AX3 of the third polarizer POL3 may be perpendicular to the fourth alignment direction AD4. That is, the axial directions of the first absorption axis AX1 and the third absorption axis AX3 are parallel to each other. An included angle β2 between the -90-degree direction of the dual-sided anti-peeping axial direction DPAX and the second absorption axis AX2 of the second polarizer POL2 is, for example, 5 degrees, but the disclosure is not limited thereto. In other embodiments, the axial direction of the first absorption axis AX1 may be parallel to the first alignment direction AD1, and the axial direction of the second absorption axis AX2 may be parallel to the second alignment direction AD2. Alternatively, the included angle between the axial direction of the first absorption axis AX1 and the first alignment direction AD1 and the included angle between the axial direction of the second absorption axis AX2 and the second alignment direction AD2 may each be in a range of 0 degrees to 15 degrees or in a range of 75 degrees to 105 degrees.

Similar to the first electrically controlled viewing angle switching device 210, in order to control the thickness of the second liquid crystal layer LCL2, the second electrically controlled viewing angle switching device 220 further includes a plurality of second spacers SP2 between the third substrate SUB3 and the fourth substrate SUB4. It is particularly noted that a second height H2 of each of the second spacers SP2 along the stacking direction (e.g., direction Z) of the third substrate SUB3 and the fourth substrate SUB4 is greater than 5 μm. Preferably, the second height H2 may be less than or equal to 15 μm.

When the third substrate SUB3 and the fourth substrate SUB4 are flexible substrates, their flexibility may deteriorate the surface flatness of the substrates during the manufacturing process and affect the thickness uniformity of the second liquid crystal layer LCL2 between the two substrates. Therefore, the design of the second height H2 of the second spacer SP2 being greater than 5 μm can effectively reduce the influence of the thickness variation of the second liquid crystal layer LCL2 due to the surface flatness of the two substrates on the uniformity of the light output brightness of the second electrically controlled viewing angle switching device 220. In addition, the flexibility in controlling the amount of liquid crystal during filling may also be increased, thereby improving process stability and quality control.

On the other hand, in one embodiment, the configuration of the first electrically controlled viewing angle switching device 210 may achieve optimal anti-peeping effect on the dual-sided anti-peeping axial direction DPAX of the display apparatus 10A at viewing angles of ±45 degrees, and the configuration of the second electrically controlled viewing angle switching device 220 may effectively suppress the light leakage of the display apparatus 10A at a viewing angle of ±60 degrees, wherein the maximum phase retardation of the first liquid crystal layer LCL1 of the first electrically controlled viewing angle switching device 210 may be in a range of 0.752 μm to 0.828 μm, and the maximum phase retardation of the second liquid crystal layer LCL2 of the second electrically controlled viewing angle switching device 220 may be in a range of 0.538 μm to 0.580 μm. Therefore, corresponding to the range design of the first height H1 of the first spacer SP1 (i.e., greater than 5 μm and less than or equal to 15 μm) and the range design of the second height H2 of the second spacer SP2 (i.e., greater than 5 μm and less than or equal to 15 μm), the absolute difference between the refractive indices of the ordinary ray and the extraordinary ray of the first liquid crystal layer LCL1 may be in a range of 0.050 to 0.166, and the absolute difference between the refractive indices of the ordinary ray and the extraordinary ray of the second liquid crystal layer LCL2 may be in a range of 0.036 to 0.116.

However, the disclosure is not limited thereto. In other embodiments, the maximum phase retardation of the first liquid crystal layer LCL1 may be adjusted according to the viewing angle design that provide the best anti-peeping effect for the display apparatus. For example, the maximum phase retardation of the first liquid crystal layer LCL1 of the first electrically controlled viewing angle switching device 210 may be in a range of 0.538 μm to 0.580 μm to filter light at viewing angles of ±60 degrees on the dual-sided anti-peeping axial direction DPAX, and the maximum phase retardation of the second liquid crystal layer LCL2 of the second electrically controlled viewing angle switching device 220 may be in a range of 0.752 μm to 0.828 μm to filter light at viewing angles of ±45 degrees on the dual-sided anti-peeping axial direction DPAX. That is, even if the ranges of the maximum phase retardation of the first liquid crystal layer LCL1 and the second liquid crystal layer LCL2 are swapped, the display apparatus 10A can still produce the best anti-peeping effect at viewing angles of ±45 degrees on the dual-sided anti-peeping axial direction DPAX, and suppress light leakage at viewing angles of ±60 degrees. Therefore, corresponding to the range of the first height H1 of the first spacer SP1 (i.e., greater than 5 μm and less than or equal to 15 μm) and the range of the second height H2 of the second spacer SP2 (i.e., greater than 5 μm and less than or equal to 15 μm), the absolute difference between the refractive indices of the ordinary ray and the extraordinary ray of the first liquid crystal layer LCL1 may be in a range of 0.036 to 0.116, and the absolute difference between the refractive indices of the ordinary ray and the extraordinary ray of the second liquid crystal layer LCL2 may be in a range of 0.050 to 0.166.

Since the distribution method of the plurality of second spacers SP2 of the second electrically controlled viewing angle switching device 220 on the third substrate SUB3 and the resulting technical effects are similar to those of the plurality of first spacers SP1 of the first electrically controlled viewing angle switching device 210 on the first substrate SUB1, please refer to the relevant paragraphs of the aforementioned embodiments for detailed descriptions which will not be repeated here.

Furthermore, in the embodiment, the second electrically controlled viewing angle switching device 220 may further selectively include a compensation film 252. The compensation film 252 is disposed between the third polarizer POL3 and the second polarizer POL2 (or the second liquid crystal layer LCL2). The out-of-plane phase retardation (Rth) of the compensation film 252 may be in a range of 100 nm to 500 nm. In the embodiment, the out-of-plane retardation of each of the compensation film 251 and the compensation film 252 is, for example, 280 nm. On the other hand, a quarter-wave plate WP1 may be further provided between the first polarizer POL1 of the first electrically controlled viewing angle switching device 210 and the display panel 100A. An included angle φ between an optical axis OX of the quarter-wave plate WP1 and the first absorption axis AX1 of the first polarizer POL1 is 45 degrees.

In the embodiment, a reflective polarizing layer (not shown) or a metal wire grid polarizing layer may be further provided between the second polarizer POL2 and the third substrate SUB3, but the disclosure is not limited thereto. Accordingly, when the display apparatus 10A operates in the anti-peeping mode, the ambient light can be reflected by the reflective polarizing layer within the anti-peeping viewing angle range, so that the display contrast of the display image within the anti-peeping viewing angle range is reduced, which may further improve the anti-peeping effect.

It should be noted that the structure of the two electrically controlled viewing angle switching devices of the embodiment may also be applied to the display apparatus 10 of FIG. 1, and in another variant implementation of the display apparatus 10A, one of the electrically controlled viewing angle switching devices may not be provided.

To sum up, in the display apparatus of an embodiment of the disclosure, the plurality of spacers of the electrically controlled viewing angle switching device define an accommodating space between the two substrates for filling the liquid crystal layer. Since the height of the spacer along the stacking direction of the two substrates is greater than 5 μm, variations in the thickness of the liquid crystal layer caused by the surface flatness of the two substrates can be effectively reduced, thereby improving the uniformity of the light output brightness of the electrically controlled viewing angle switching device. In addition, the flexibility in controlling the amount of liquid crystal during filling may also be increased, thereby improving process stability and quality control.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. An electrically controlled viewing angle switching device, comprising:
a first substrate and a second substrate, overlapped with each other along a stacking direction;
a first liquid crystal layer, disposed between the first substrate and the second substrate;
a first alignment layer, disposed between the first substrate and the first liquid crystal layer and having a first alignment direction;
a second alignment layer, disposed between the second substrate and the first liquid crystal layer and having a second alignment direction, wherein an included angle between the first alignment direction and the second alignment direction is in a range of 165 degrees to 195 degrees;
a plurality of spacers, disposed between the first substrate and the second substrate, wherein each of the plurality of spacers has a height along the stacking direction, and the height is greater than 5 μm;
a first polarizer, disposed on one side of the first alignment layer facing away from the first liquid crystal layer and having a first absorption axis, wherein an included angle between an axial direction of the first absorption axis and the first alignment direction is in a range of 0 degrees to 15 degrees or in a range of 75 degrees to 105 degrees; and
a second polarizer, disposed on one side of the second alignment layer facing away from the first liquid crystal layer and having a second absorption axis, wherein an included angle between an axial direction of the second absorption axis and the second alignment direction is in a range of 0 degrees to 15 degrees or in a range of 75 degrees to 105 degrees.

2. The electrically controlled viewing angle switching device according to claim 1, wherein a percentage value of an orthographic projection area of the plurality of spacers on a substrate surface of the first substrate to an area of the substrate surface is greater than 0.5% and less than 5%.

3. The electrically controlled viewing angle switching device according to claim 1, wherein a maximum width of each of the plurality of spacers is less than 20 μm.

4. The electrically controlled viewing angle switching device according to claim 1, wherein the height of each of the plurality of spacers is less than or equal to 15 μm.

5. The electrically controlled viewing angle switching device according to claim 1, wherein the plurality of spacers are arranged along at least one direction with a spacing, and the spacing is greater than 83.5 μm and less than 270 μm.

6. The electrically controlled viewing angle switching device according to claim 1, wherein the electrically controlled viewing angle switching device has a dual-sided anti-peeping axial direction, and the first alignment direction is perpendicular to the dual-sided anti-peeping axial direction.

7. The electrically controlled viewing angle switching device according to claim 1, further comprising:
a compensation film, disposed between the first polarizer and the second polarizer.

8. A display apparatus, comprising:
a display panel; and
a first electrically controlled viewing angle switching device, disposed overlapping the display panel, and comprising:
a first substrate and a second substrate, overlapped with each other along a stacking direction;
a first liquid crystal layer, disposed between the first substrate and the second substrate;
a first alignment layer, disposed between the first substrate and the first liquid crystal layer and having a first alignment direction;
a second alignment layer, disposed between the second substrate and the first liquid crystal layer and having a second alignment direction, wherein an included angle between the first alignment direction and the second alignment direction is in a range of 165 degrees to 195 degrees;
a plurality of first spacers, disposed between the first substrate and the second substrate, wherein each of the plurality of first spacers has a first height along the stacking direction, and the first height is greater than 5 μm;
a first polarizer, disposed on one side of the first alignment layer facing away from the first liquid crystal layer and having a first absorption axis, wherein an included angle between an axial direction of the first absorption axis and the first alignment direction is in a range of 0 degrees to 15 degrees or in a range of 75 degrees to 105 degrees; and
a second polarizer, disposed on one side of the second alignment layer facing away from the first liquid crystal layer and having a second absorption axis, wherein an included angle between an axial direction of the second absorption axis and the second alignment direction is in a range of 0 degrees to 15 degrees or in a range of 75 degrees to 105 degrees.

9. The display apparatus according to claim 8, wherein a percentage value of an orthographic projection area of the plurality of first spacers on a substrate surface of the first substrate to an area of the substrate surface is greater than 0.5% and less than 5%.

10. The display apparatus according to claim 8, further comprising:
a backlight module, disposed on one side of the first electrically controlled viewing angle switching device facing away from the display panel, wherein the display panel includes an electrically controlled liquid crystal cell and a third polarizer, and the electrically controlled liquid crystal cell is disposed between the second polarizer and the third polarizer.

11. The display apparatus according to claim 8, further comprising:
a second electrically controlled viewing angle switching device, comprising:
a third substrate and a fourth substrate, overlapped with each other along the stacking direction;
a second liquid crystal layer, disposed between the third substrate and the fourth substrate;
a third alignment layer, disposed between the third substrate and the second liquid crystal layer and having a third alignment direction;
a fourth alignment layer, disposed between the fourth substrate and the second liquid crystal layer and having a fourth alignment direction, wherein an included angle between the third alignment direction and the fourth alignment direction is in a range of 165 degrees to 195 degrees;
a plurality of second spacers, disposed between the third substrate and the fourth substrate, wherein each of the plurality of second spacers has a second height along the stacking direction, and the second height is greater than 5 μm; and
a third polarizer, disposed on one side of the second liquid crystal layer facing away from the first electrically controlled viewing angle switching device and having a third absorption axis, wherein the second polarizer is located between the first liquid crystal layer and the second liquid crystal layer, and an axial direction of the third absorption axis is parallel to the axial direction of the first absorption axis.

12. The display apparatus according to claim 11, wherein the first electrically controlled viewing angle switching device and the second electrically controlled viewing angle switching device are located on one side of a display surface of the display panel.

13. The display apparatus according to claim 12, further comprising:
a quarter-wave plate, disposed between the display panel and the first polarizer, wherein an included angle between an optical axis of the quarter-wave plate and the first absorption axis of the first polarizer is 45 degrees.

14. The display apparatus according to claim 11, wherein the first electrically controlled viewing angle switching device further includes a first compensation film disposed between the first polarizer and the second polarizer, and the second electrically controlled viewing angle switching device further includes a second compensation film disposed between the second polarizer and the third polarizer.
